(19) United States
(12) Patent Application Publication
(10) Pub. No.: US 2024/0095549 A1
(43) Pub. Date: Mar. 21, 2024

(54) METHODS AND SYSTEMS FOR PREDICTIVE ANALYSIS OF TRANSACTION DATA USING MACHINE LEARNING

(71) Applicant: FMR LLC, Boston, MA (US)

(72) Inventors: Xiang Song, Brookline, MA (US); Abhinav Malhotra, Austin, TX (US); Dennis Robert Bowden, Mountain Lakes, NJ (US); Gunjan Narulkar, Bangalore (IN); Alain Wilkinson, Natick, MA (US); Manish Worlikar, Flower Mound, TX (US); Nicholas Luc Steenhaut, Jamaica Plain, MA (US)

(21) Appl. No.: 18/367,563

(22) Filed: Sep. 13, 2023

Related U.S. Application Data
(60) Provisional application No. 63/406,907, filed on Sep. 15, 2022.

(51) Int. Cl. G06N 5/022

(52) U.S. Cl. CPC G06N 5/022

(57) ABSTRACT

Methods and apparatuses are described for predictive analysis of transaction data using machine learning. A server computing device trains a plurality of machine learning models using historical transaction data for a set of entities as input to predict a likelihood of future transaction activity for each of the entities, each machine learning model trained on a different target transaction variable. The server computing device executes each of the plurality of machine learning models to generate, for each entity, a predicted likelihood value for a future transaction associated with the entity and each of the target transaction variables. The server computing device transmits the predicted likelihood values for each entity to a remote computing device for display.

### RELATED APPLICATION(S)

This application claims priority to U.S. Provisional Patent Application No. 63/406,907, filed on Sep. 15, 2022, the entirety of which is incorporated by reference herein.

### TECHNICAL FIELD

This application relates generally to methods and apparatuses, including computer program products, for predictive analysis of transaction data using machine learning.

### BACKGROUND

In many specialized industries, such as financial services, organizations continually seek to determine future trends and outcomes based upon historical data. In one example, asset management firms and related entities may want to predict purchase transactions and/or redemption transactions that will be executed by their customers (i.e., registered investment advisors (RIAs)) in the coming month, quarter, and/or year. Typically, these asset managers will perform various data mining and statistical analysis techniques on historical transaction data involving these RIAs in an attempt to glean insights and predictions for future transaction activity. Exemplary existing systems utilize techniques such as rules-based recommendation to generate their predictions—e.g., such systems implement decision rules like recent significant purchase or redemption activities as the leading recommendation indicator to predict future activities. However, often these systems produce less-than-accurate predictions and they typically do not leverage advanced artificial intelligence and/or machine learning techniques-which results in lower confidence in the predictions and produces fewer actionable insights that lead to direct benefits for the organization.

### SUMMARY

Therefore, what is needed are computerized methods and systems to overcome the above-described challenges and provide for an automated, predictive computing system that leverages registered investment advisor (RIA) and market data to forecast future transactions of RIAs that helps asset managers increase their sales and reduce redemption.

The invention, in one aspect, features a system for predictive analysis of transaction data using machine learning. The system includes a server computing device comprising a memory for storing programmatic instructions and a processor that executes the programmatic instructions. The server computing device trains a plurality of machine learning models using historical transaction data for a set of entities as input to predict a likelihood of future transaction activity for each of the entities including: creating an initial feature set based upon the historical transaction data for one or more rolling time periods, determining a plurality of target transaction variables based upon the historical transaction data for one or more rolling time periods, generating a variable-specific feature set for each target transaction variable using a feature selection process on the initial feature set, and training a plurality of machine learning models using the historical transaction data, each machine learning model trained on a variable-specific feature set for a different target transaction variable. The server computing device executes each of the plurality of trained machine learning models to generate, for each entity, a predicted likelihood value for a future transaction associated with the entity and each of the target transaction variables. The server computing device transmits the predicted likelihood values for each entity to a remote computing device for display.

The invention, in another aspect, features a computerized method of predictive analysis of transaction data using machine learning. A server computing device trains a plurality of machine learning models using historical transaction data for a set of entities as input to predict a likelihood of future transaction activity for each of the entities including: creating an initial feature set based upon the historical transaction data for one or more rolling time periods, determining a plurality of target transaction variables based upon the historical transaction data for one or more rolling time periods, generating a variable-specific feature set for each target transaction variable using a feature selection process on the initial feature set, and training a plurality of machine learning models using the historical transaction data, each machine learning model trained on a variable-specific feature set for a different target transaction variable. The server computing device executes each of the plurality of trained machine learning models to generate, for each entity, a predicted likelihood value for a future transaction associated with the entity and each of the target transaction variables. The server computing device transmits the predicted likelihood values for each entity to a remote computing device for display.

Any of the above aspects can include one or more of the following features. In some embodiments, each machine learning model comprises a tree-based machine learning model. In some embodiments, each of the plurality of target transaction variables corresponds to a different type of classification. In some embodiments, the type of classification comprises a category or an asset class.

In some embodiments, the feature selection process comprises a pipeline that performs a separate feature selection for each target transaction variable using the initial feature set to generate the variable-specific feature set for each target transaction variable. In some embodiments, the pipeline includes a correlative feature selector that is applied to reduce the number of features in the initial feature set before the separate feature selection is performed.

In some embodiments, executing each of the plurality of trained machine learning models comprises generating, for each entity and trained machine learning model combination, model feature data by combining entity-specific historical transaction data and a variable-specific feature set for the target transaction variable associated with the trained machine learning model, and executing the trained machine learning model using the model feature data as input to generate a predicted likelihood value for a future transaction associated with the entity and the target transaction variable.

In some embodiments, transmitting the predicted likelihood values for each entity to a remote computing device for display comprises merging screening attributes with the predicted likelihood values for each entity to generate a merged output dataset and transmitting the merged output dataset to the remote computing device. In some embodiments, the remote computing device generates a user interface screen for display of the merged output data. In some embodiments, the server computing device periodically validates at least one of performance or accuracy of the plurality of trained machine learning models using newly-received historical transaction data.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for predictive analysis of transaction data using machine learning.

FIG. 2 is a flow diagram of a computerized method of predictive analysis of transaction data using machine learning.

FIGS. 3A to 3C comprise a flow diagram of an exemplary process for training a plurality of ML models as performed by model training module.

FIG. 4 is a flow diagram of an exemplary process for generating predicted likelihood values for future transactions as performed by model execution module using the trained ML models.

FIG. 5 is an exemplary prediction output matrix generated by model execution module for a given RIA entity.

FIG. 6 is a flow diagram of an exemplary computerized process for providing predicted likelihood values generated by model execution module for consumption by downstream computing devices.

FIG. 7 is an exemplary user interface screen showing a summary interface with overall transaction probabilities by RIA client.

FIG. 8 is an exemplary user interface screen showing an RIA opportunity profile for a selected RIA client.

FIG. 9 is an exemplary user interface screen showing a prediction ‘heat map’ for a selected RIA client.

FIG. 10 is a flow diagram of an exemplary process for validating the predictions generated by the trained ML models.

### DETAILED DESCRIPTION

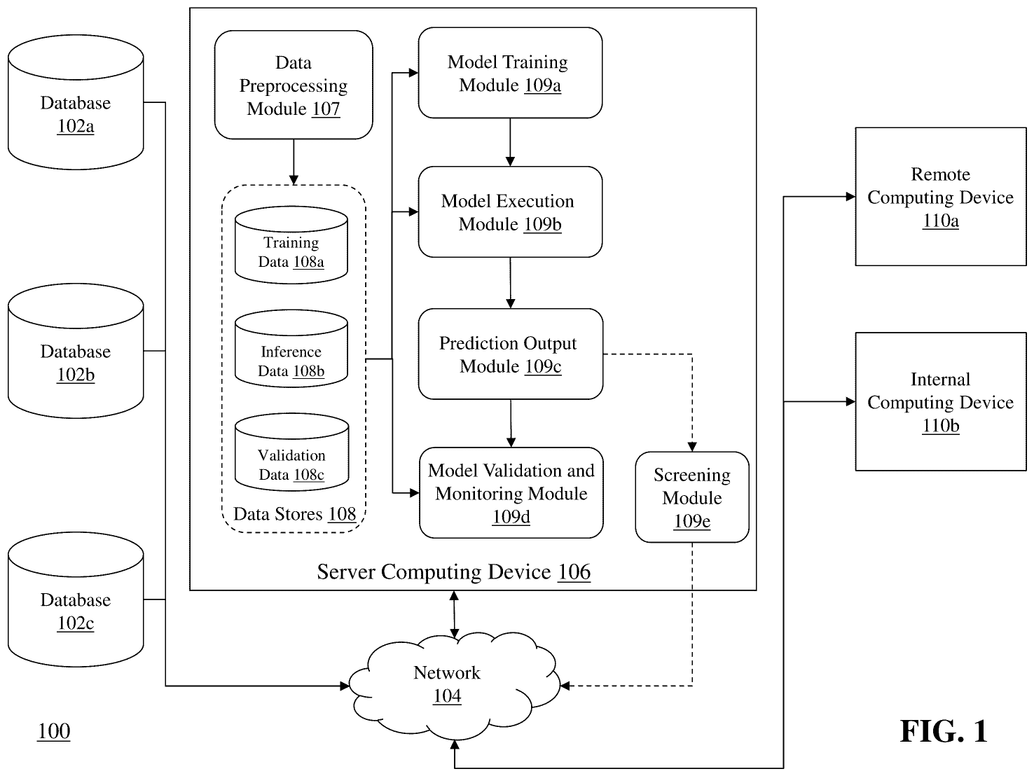

FIG. 1 is a block diagram of a system 100 for predictive analysis of transaction data using machine learning. System 100 includes databases 102a-102c, communications network 104, server computing device 106 that comprises data preprocessing module 107, data stores 108, model training module 109a, model execution module 109b, prediction output module 109c, model validation and monitoring module 109d, and screening module 109e, and recipient computing devices such as remote computing device 110a and internal computing device 110b.

Databases 102a-102c comprise a computing device (or in some embodiments, a set of computing devices) coupled to server computing device 106 via network 104. Databases 102a-102c are configured to receive, generate, and store specific segments of data relating to the process of predictive analysis of transaction data using machine learning as described herein. In some embodiments, all or a portion of the databases 102a-102c can be integrated with server computing device 106 or be located on a separate computing device or devices. Databases 102a-102c can comprise one or more databases configured to store portions of data used by the other components of the system 100, as will be described in greater detail below.

Network 104 enables components of system 100 to communicate with each other for the purpose of performing the process of predictive analysis of transaction data using machine learning as described herein. Network 104 is typically a wide area network, such as the Internet and/or a cellular network. In some embodiments, network 104 is comprised of several discrete networks and/or sub-networks (e.g., LAN to WAN, cellular to Internet, PSTN to Internet, PSTN to cellular, etc.).

Server computing device 106 is a device including specialized hardware and/or software modules that execute on a processor and interact with memory modules of the server computing device 106, to receive data from other components of system 100, transmit data to other components of system 100, and perform functions for predictive analysis of transaction data using machine learning as described herein. Server computing device 106 includes data preprocessing module 107, data stores 108 comprising training data 108a, inference data 108b, and validation data 108c, and modules 109a-109e that are located on one or more memory modules and/or that execute on one or more processors of server computing device 106. In some embodiments, modules 107 and 109a-109e are specialized sets of computer software instructions programmed onto one or more dedicated processors in server computing device 106 and can include specifically-designated memory locations and/or registers for executing the specialized computer software instructions. It should be appreciated that any number of computing devices, arranged in a variety of architectures, resources, and configurations (e.g., cluster computing, virtual computing, cloud computing) can be used without departing from the scope of the invention. The exemplary functionality of modules 107 and 109a-109e, and data stores 108a-108c, are described in detail throughout this specification.

Remote computing device 110a and internal computing device 110b connect to network 104 in order to communicate with the server computing device 106 to receive output and provide input relating to the process of predictive analysis of transaction data using machine learning as described herein. Exemplary computing devices 110a-110b can include, but are not limited to, client computing devices such as smartphones, tablets, laptops, desktops, or other similar devices; or other server computing devices that consume data generated by server computing device 106. For example, remote computing device 110a can be a client computing device or client-managed server computing device that connects to server computing device 106 and retrieves data from device 106 using a secure file transfer protocol (SFTP) proxy and/or application programming interface (API). For example, internal computing device 110b can be a client computing device or server computing device that is managed by the same organization that manages system 100 and is used to provide user interfaces, reports, and other types of visualizations of the output data from server computing device 106. It should be appreciated that other types of devices that are capable of connecting to the components of system 100 can be used without departing from the scope of invention.

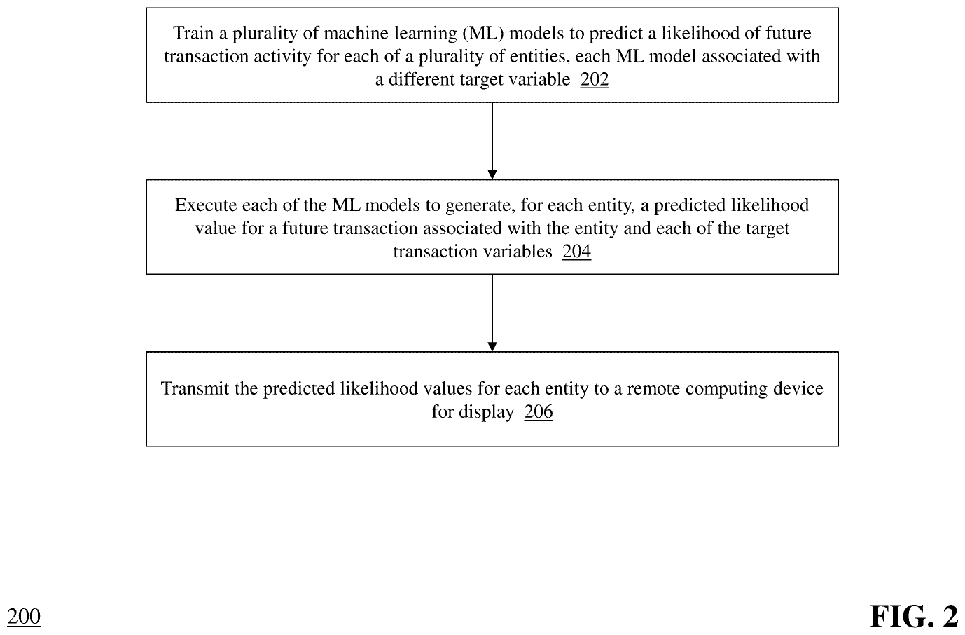

FIG. 2 is a flow diagram of a computerized method 200 of predictive analysis of transaction data using machine learning, using system 100 of FIG. 1. In some embodiments, the method 200 described herein can be separated into two phases: a model training phase and a model execution phase. Generally, during the training phase, server computing device 106 analyzes historical transaction data for one or more time periods to train a plurality of machine learning (ML) models to predict a likelihood of future transaction activity, where each ML model is trained on a different target transaction variable. Generally, during the execution phase, server computing device 106 executes the trained ML models to generate, for each of a plurality of different entities, a predicted likelihood value for a future transaction associated with the entity and the target transaction variable for each ML model. Further details on each of the training phase and the execution phase are provided below.

It should be appreciated that, in some embodiments, the model training and model execution phases can be performed by server computing device 106 asynchronously, i.e., models are trained first and then executed. However, in some embodiments, the model training and model execution phases can happen in parallel, where at least some of the ML models are trained while other already-trained ML models are executed.

Beginning with the training phase, model training module 109a trains (step 202) a plurality of machine learning (ML) models using historical transaction data for a set of entities as input to predict a likelihood of future transaction activity for each of the entities, each machine learning model trained on a different target transaction variable. In some embodiments, data preprocessing module 107 of server computing device 106 can perform one or more processing steps to (i) retrieve data from databases 102a-102c and (ii) prepare the retrieved data for storage in data stores 108a-108c, prior to training the ML models.

Data preprocessing module 107 can connect to databases 102a-102c and retrieve certain portions of data stored therein. In some embodiments, database 102a comprises data relating to one or more registered investment advisors (RIAs), including information such as the RIA firm name, address, registration number, assets being managed by the RIA (e.g., size, dollar amount, investment strategies, asset mix, asset classes/areas, YTD growth, etc.). In some embodiments, database 102b comprises market index data relating to, e.g., historical performance data associated with one or more financial markets (S&P, NASDAQ, etc.). In some embodiments, database 102c comprises historical transaction data associated with the RIAs in database 102a, such as purchase data, redemption data, fund family data, business calendar data, and the like. Data preprocessing module 107 can retrieve relevant data from databases 102a-102c and determine, e.g., a threshold number of top-performing RIAs to be used for training and execution of ML models as described herein. In one example, module 107 can select the top 2,500 RIAs based on any number of performance criteria (e.g., purchase volume, assets under management, etc.) and retrieve data relating to those RIAs from databases 102a-102c.

In some embodiments, data preprocessing module 107 stores data from the top-performing RIAs in training data store 108a, to be used for training ML models. In some embodiments, module 107 stores data from all RIAs in inference data store 108b, to be used in executing the trained ML models for a particular RIA to produce the predictions as described herein. Also, in some embodiments, data preprocessing module 107 stores recent transaction data from top-performing RIAs in validation data store 108c, to be used in validating the performance of the trained ML models over time and determining whether re-training should occur.

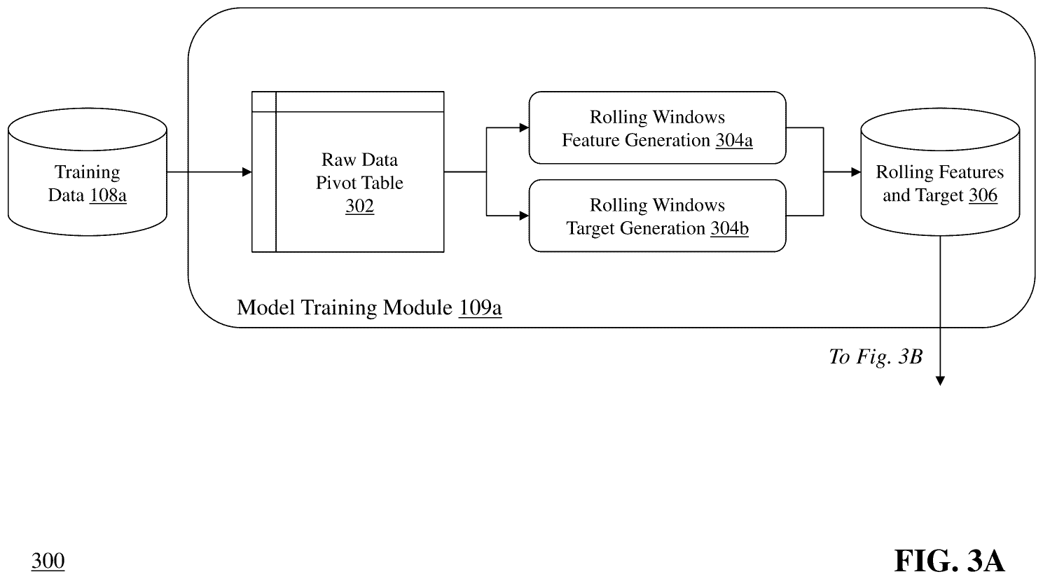

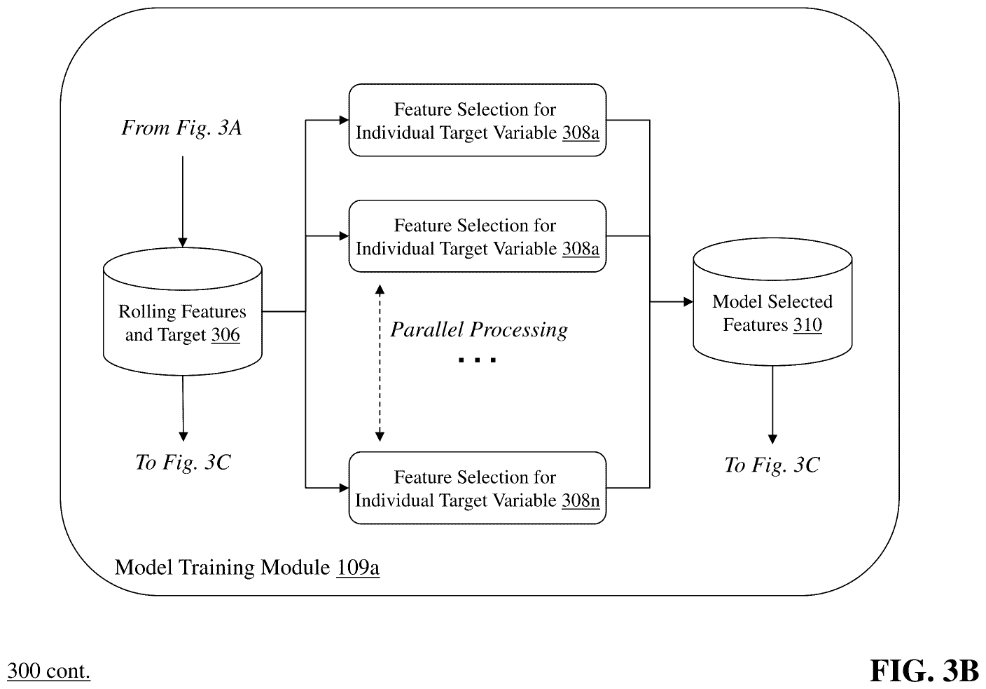

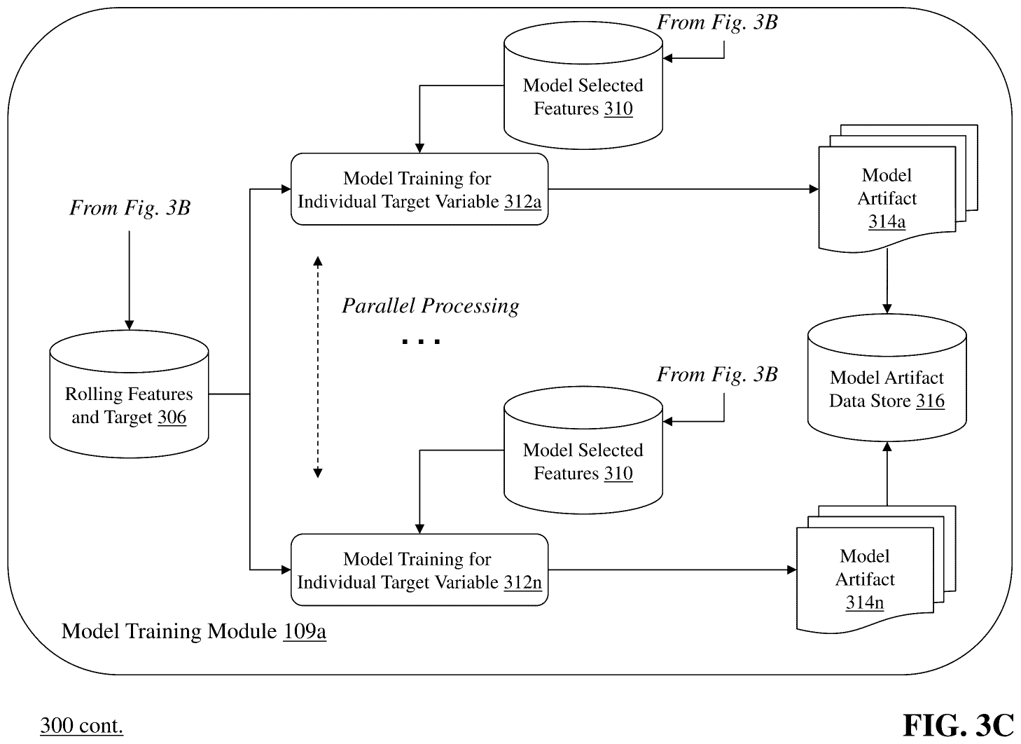

Once module 107 has populated data stores 108 as described above, model training module 109a can begin the training phase to train the plurality of ML models. FIGS. 3A to 3C comprise a flow diagram of an exemplary process 300 for training the plurality of ML models as performed by model training module 109a. As shown in FIG. 3A, model training module 109a starts by initiating a feature selection process using the raw training data stored in training data store 108a. Module 109a generates a raw training data pivot table from data store 108a and performs a rolling windows feature generation step 304a and a rolling windows target generation step 304b on the raw training data.

In this context, the rolling windows relate to temporal aspects of the historical transaction data and or future transaction activity. In some embodiments, the rolling windows are historical and/or future time periods used to analyze the historical transaction data and to generate predictions of future transaction activity. The rolling windows feature generation step 304a can comprise analysis of the raw training data 302 for each of a plurality of historical time periods (e.g., last 30 days, last 60 days, last 90 days) to determine an initial set or sets of features that are useful and/or relevant for predicting future transaction activity, independent from the particular target transaction variable that may be desired. In some embodiments, an initial set of features can comprise thousands of features for, e.g., each rolling window. The rolling windows target generation step 304b can comprise analysis of the raw training data 302 to determine a set of target transaction variables for prediction of future transaction activity. In some embodiments, each target transaction variable corresponds to a different category, asset class, or other type of classification for which a predicted likelihood of a future transaction is desired. Exemplary target transaction variables include, but are not limited to, Morningstar® categories (e.g., U.S. stocks (large, mid-cap, small); sector stocks; international stocks; market indices; bonds; etc.). As can be appreciated, each ML model is trained to predict the likelihood of a future transaction for a given target transaction variable. The rolling window aspect can model the prediction for a given future time period (e.g., next 30 days) and in some embodiments, the prediction is further modeled using a target transaction value threshold (e.g., purchase transactions over $500,000). It should be understood that other types of target transaction variables, rolling windows, and/or threshold transaction values can be utilized with the technology described herein. Module 109a stores the rolling windows feature set(s) and the target transaction variables in rolling features and target data store 306.

Turning to FIG. 3B, once the initial feature set(s) and target transaction variables are generated, module 109a generates a feature set for each individual target transaction variable using, e.g., a parallel processing approach. Module 109a retrieves data from data store 306 as input to a feature selection pipeline which takes the initial feature set(s) and target transaction variables and, for each target transaction variable, performs a separate feature selection process 308a-308n to create a set of model selected features 310 for each target variable. In some embodiments, the feature selection pipeline comprises a correlative feature selector which is applied to the initial set of features to, e.g., remove highly correlated features. As an example, the correlative feature selector can reduce the initial feature set from 2,500 features to 1,200-1,500 features. Then, the separate process for each target transaction variable can determine a preferred set of features (e.g., 50-100 features) that are most relevant to predicting a likelihood of future transaction activity for the specific target transaction variable based upon, e.g., the historical data for one or more rolling windows. It should be appreciated that the feature set generated for a first target transaction variable (e.g., U.S. equity) may be different from the feature set generated for a second target transaction variable (e.g., international equity).

Turing to FIG. 3C, model training module 109a uses data from the rolling features and target data store 306 to train a plurality of machine learning (ML) models 312a-312n in parallel, each machine learning model trained to predict a future transaction likelihood for a different target transaction feature. To train each model, module 109a retrieves the feature set for the specific target transaction feature from data store 310 and retrieves the corresponding historical transaction data and target data from data store 306. Then, module 109a trains a tree-based ML model (e.g., a Random Forest model (as described in L. Breiman, “Random Forests,” Machine Learning, 45, 5-32 (2001) (which is incorporated by reference herein)) or an XGBoost model (as described in T. Chen and C. Guestrin, “XGBoost: A Scalable Tree Boosting System,” KDD '16: Proceedings of the 22^{nd} ACM SIGKDD International Conference on Knowledge Discovery and Data Mining, August 2016, pp. 785-794 (which is incorporated by reference herein)) to generate a predicted likelihood of future transaction activity for the associated target transaction variable. The result of model training is a model artifact 314a-314n for each target transaction variable that comprises a trained ML model capable of receiving historical transaction data for a given RIA entity and generating a value that represents a predicted likelihood that the RIA entity will conduct future transaction activity for the associated target transaction variable during one or more windows. Each of the model artifacts 314a-314n are stored in a model artifact data store 316.

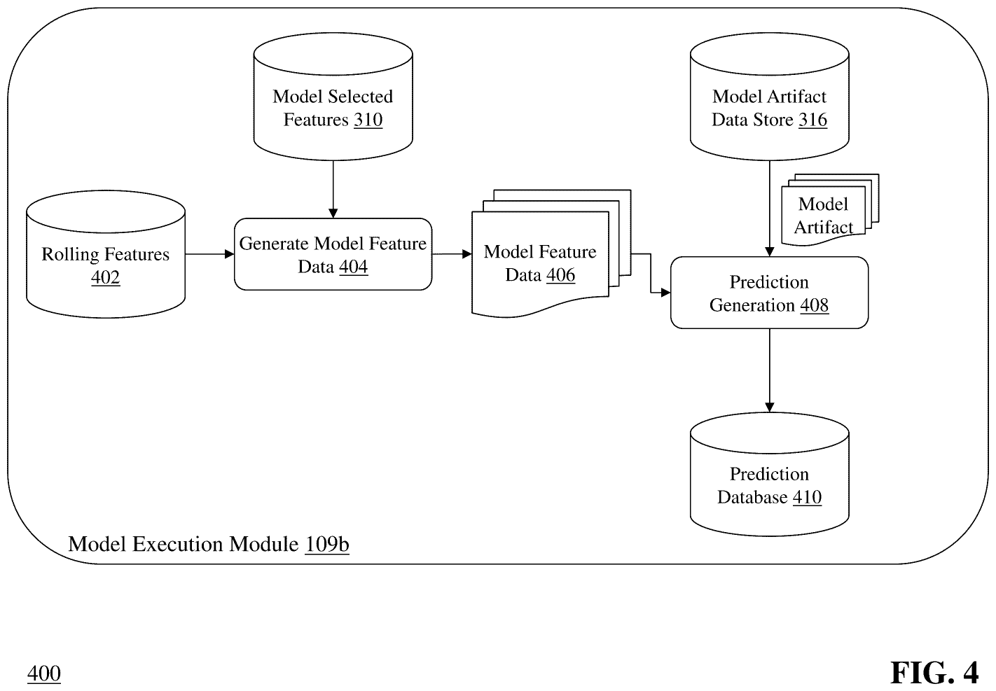

Once each of the plurality of ML models has been trained, server computing device 106 can initiate the model execution phase. Turning back to FIG. 2, model execution module 109b executes (step 204) each of the plurality of ML models to generate, for each entity, a predicted likelihood value for a future transaction associated with the entity and each of the target transaction variables. FIG. 4 is a flow diagram of an exemplary process 400 for generating predicted likelihood values for future transactions as performed by model execution module 109a using the trained ML models. As shown in FIG. 4, model execution module 109b retrieves the rolling features data 402 (which can be a database that is part of 306 or a separate database) and model selected features data 310 as generated by model training module 109a and performs the step 404 of generating model feature data to be used as input for execution of the plurality of trained ML models. In some embodiments, model execution module 109b generates model feature data for all of the RIA entities in parallel during step 404 by, e.g., retrieving RIA-specific rolling feature data from 402 and model selected features from 310. The result of step 404 is a plurality of model feature data sets 406 that are used as input to a specific trained ML model (i.e., for a particular target transaction variable) to generate predictions for a specific RIA entity. Additional information on feature selection is described in RC. Chen et al., “Selecting critical features for data classification based on machine learning methods,” Journal of Big Data, 7(1), 52 (2020) (which is incorporated by reference herein).

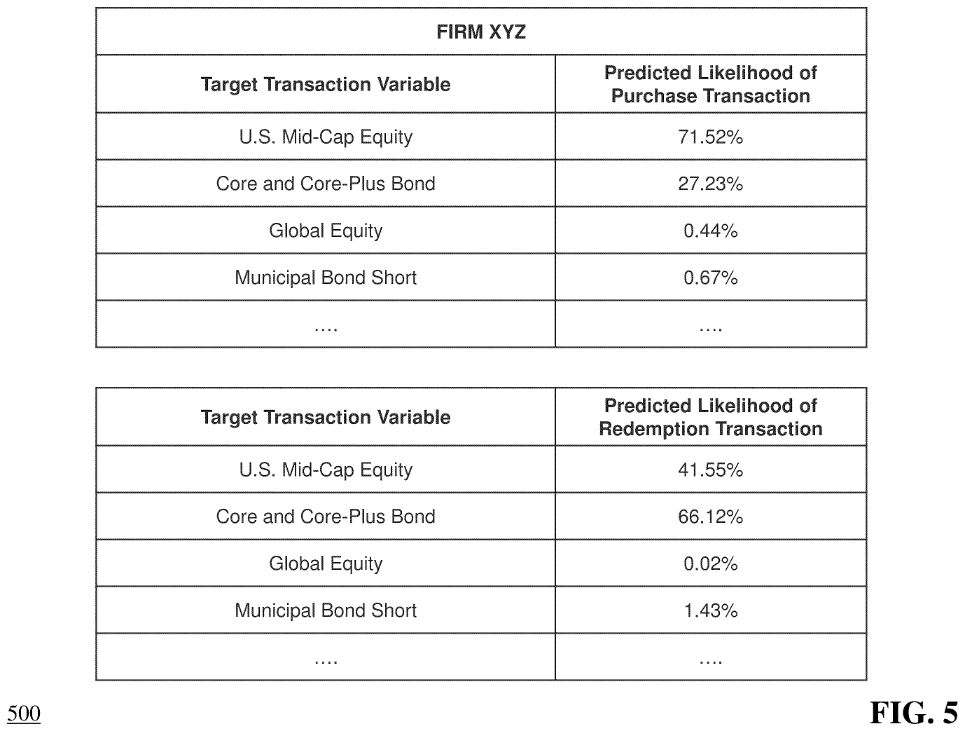

Model execution module 109b uses the model feature data sets 406 as input for execution of prediction generation process 408, which retrieves each model artifact (i.e., the trained ML model) from data store 316 and executes each trained ML model using the corresponding model feature data set as input to generate a predicted likelihood value that the RIA entity associated with the historical transaction data will execute a certain transaction for the target transaction variable in an upcoming time period. As one example, a trained ML model may be configured to generate predictions of whether an RIA is likely to accumulate purchase transactions over $500,000 in the next 30 days for U.S. equity. Model execution module 109b executes this trained ML model using input data associated with a specific RIA firm (Firm XYZ) to generate a predicted likelihood value that the specific RIA firm will accumulate (i.e., purchase) over $500,000 in U.S. equity in the next 30 days. Model execution module 109b can execute each of the trained ML models for each of the RIAs to generate a matrix of predicted likelihood values e.g., a set of values for each RIA and each target transaction variable. The matrix of predicted likelihood values is stored in prediction database 410. In some embodiments, the predicted likelihood values can be in the form of a decimal value between 0 and 1 (where values closer to zero indicate a lower likelihood and values closer to 1 indicate a higher likelihood). In some embodiments, the predicted likelihood values can be in the form of a percentage between 0 and 100 (where values closer to zero indicate a lower likelihood and values closer to 100 indicate a higher likelihood). An exemplary prediction output matrix 500 generated by model execution module 109b for a given RIA entity is shown in FIG. 5. For example, model execution module 109b predicts that there is a 71.52% likelihood that Firm XYZ will accumulate purchase transactions for $500,000 or more of U.S. Mid-Cap Equity assets in the next 30 days. In another example, model execution module 109b predicts that there is a 41.55% likelihood that Firm XYZ will execute a redemption transaction for $500,000 or more of U.S. Mid-Cap Equity assets in the next 30 days. In some embodiments, the prediction output matrix for each RIA entity is stored in prediction database 410 as a flat file and/or a delimited file (e.g., csv file). In some embodiments, the prediction output matrix for each ML model is stored as a flat file and/or delimited file.

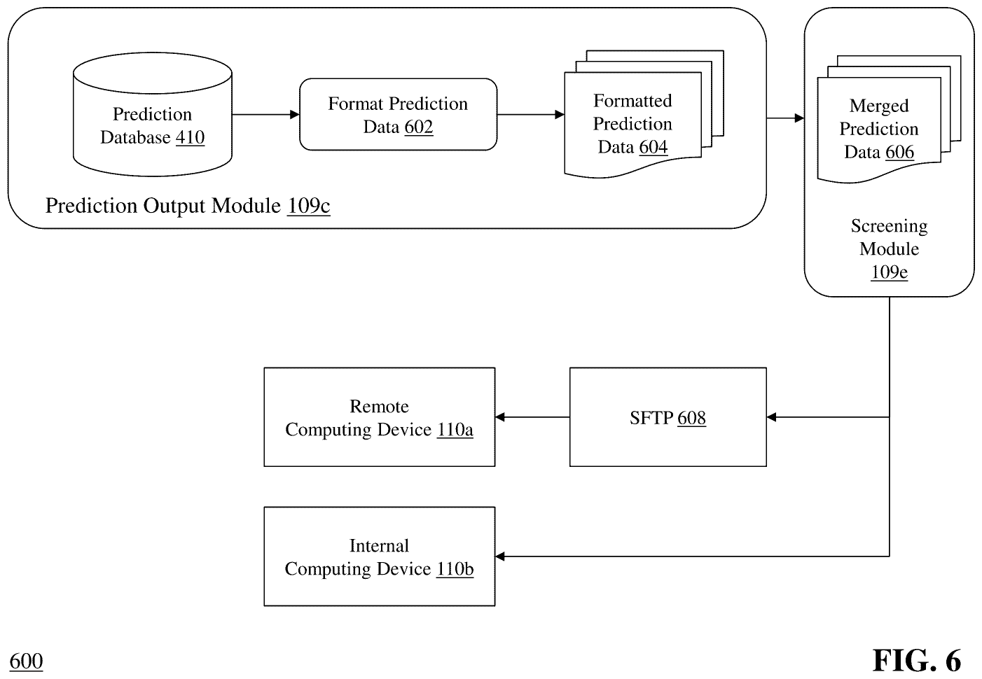

Turning back to FIG. 2, once the prediction data is generated and stored, server computing device 106 transmits (step 206) the predicted likelihood values for each entity to a remote computing device for display. In some embodiments, prediction output module 109c retrieves the prediction data and prepares the data for transmission to one or more recipient computing devices such as remote computing device 110a and/or internal computing device 110b. FIG. 6 is a flow diagram of an exemplary process 600 for providing predicted likelihood values generated by model execution module 109b for consumption by downstream computing devices, or at the client computing device or a client server. As shown in FIG. 6, prediction output module 109c retrieves the prediction data from database 410 and formats the prediction data in step 602. For example, module 109c can transform the flat file/delimited file stored in database 410 into a different format (e.g., XML, JSON) that may be preferred by one or more of computing devices 110a, 110b. In some embodiments, module 109c can arrange the prediction data to conform to a structure that is used by one or more APIs and/or SFTP sites that receive requests for the data from recipient computing devices 110a, 110b. The result of step 602 is formatted prediction data 604 that is then transmitted to screening module 109e.

Screening module 109e consumes the formatted prediction data 604 output from prediction output module 109c and appends the formatted prediction data 604 with attributes that are specific to individual asset managers and/or a consuming organization. In some embodiments, the appended attributes capture measures of historical association of the asset manager (and/or consuming organization) with the RIA, along with industry standard performance metrics of RIA's current portfolio (average) vis-à-vis the asset manager's products. The appended attributes are surfaced with the formatted prediction data 604 output from prediction output module 109c. Advantageously, the appended attributes enable a downstream asset manager (and/or consuming organization) to further screen RIA opportunities and obtain a filtered list of outreach RIAs. For example, the attributes can provide further filtering of RIAs where the asset manager (and/or consuming organization) has a competitive advantage over what the RIA currently holds. Exemplary screening attributes can include, but are not limited to, asset manager recent growth, asset manager yearly median percentage, expense ratio advantage, Morningstar® rating advantage, RIA average expense ratio, RIA average Morningstar® rating, among others.

Screening module 109e merges the screening attributes with the formatted prediction data 604 received from prediction output module 109c to generate merged prediction data 606, and module 109e transmits the merged data 606 to downstream computing devices. In the example shown in FIG. 6, screening module 109e of server computing device 106 transmits the formatted and merged prediction data 606 to a remote computing device 608 (i.e., an SFTP server) which makes the prediction data available to computing devices 110a, 110b upon request. In some embodiments, screening module 109e can directly deliver the prediction data to remote computing device 110a via the SFTP protocol or another secure protocol.

As can be appreciated, recipient computing devices 110a, 110b can utilize the prediction data for any number of different business objectives or purposes. In some embodiments, the prediction data can be analyzed by an organization's marketing or sales personnel to determine, e.g., which RIA customers to target in the next 30 or 60 days. For example, if the prediction data indicates that a particular set of RIA customers have a high likelihood of executing a purchase transaction for a specific asset class in the next 30 days, a sales team may want to focus their efforts on contacting the RIA customers to provide them with information, support, etc. regarding sales opportunities to purchase assets in that class.

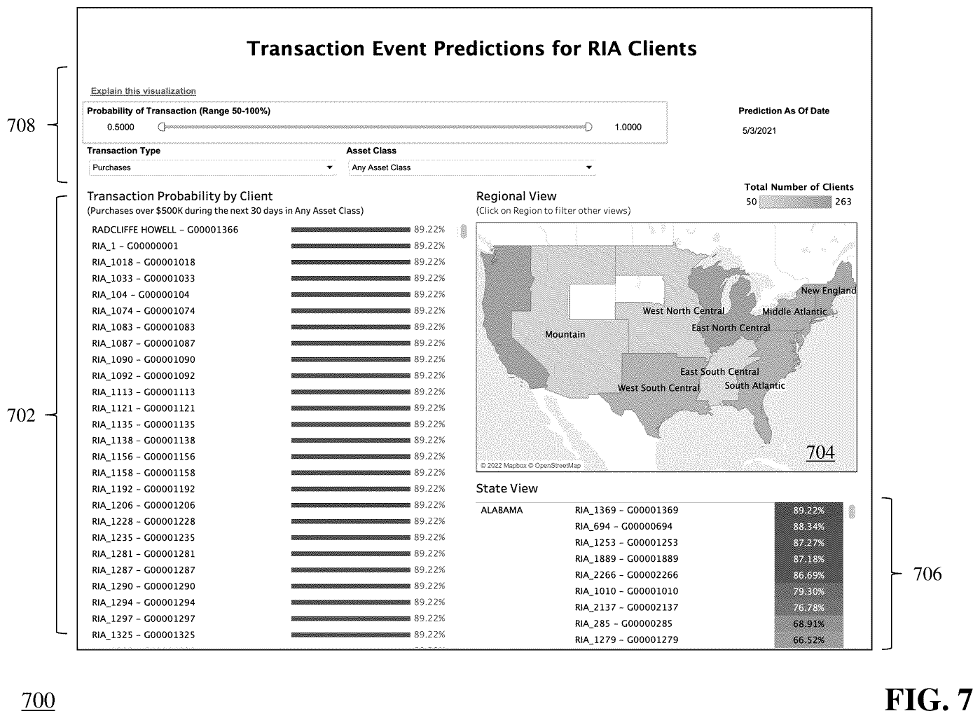

FIGS. 7 to 9 comprise exemplary user interface screens generated by one or more recipient computing devices (e.g., internal computing device 110b) upon receipt of the prediction data generated by server computing device 106. FIG. 7 is an exemplary user interface screen 700 showing a summary interface with overall transaction probabilities by RIA client. The user interface screen includes table 702 showing the overall transaction probability for each RIA client sorted from highest probability to lowest probability. The user interface screen also includes a map view 704 that enables a user to select specific parts of the country to view probability data for RIA clients in these regions. As shown, the user has selected the “East South Central” region in 704 and then 706 will display the states in this region, including Alabama (as shown in section 706. The corresponding table lists the RIA clients (e.g., based upon their firm data as stored in database 102a) ranked from highest to lowest probability. The user interface screen 700 also includes input controls 708 for adjusting the criteria used for selecting the prediction data displayed in the main portion of the interface screen. Using this interface screen, a user can quickly determine which RIA clients in certain areas may be more worthwhile to target in the next time period. For example, sales efforts in a particular geographic location can be focused using the interface 702.

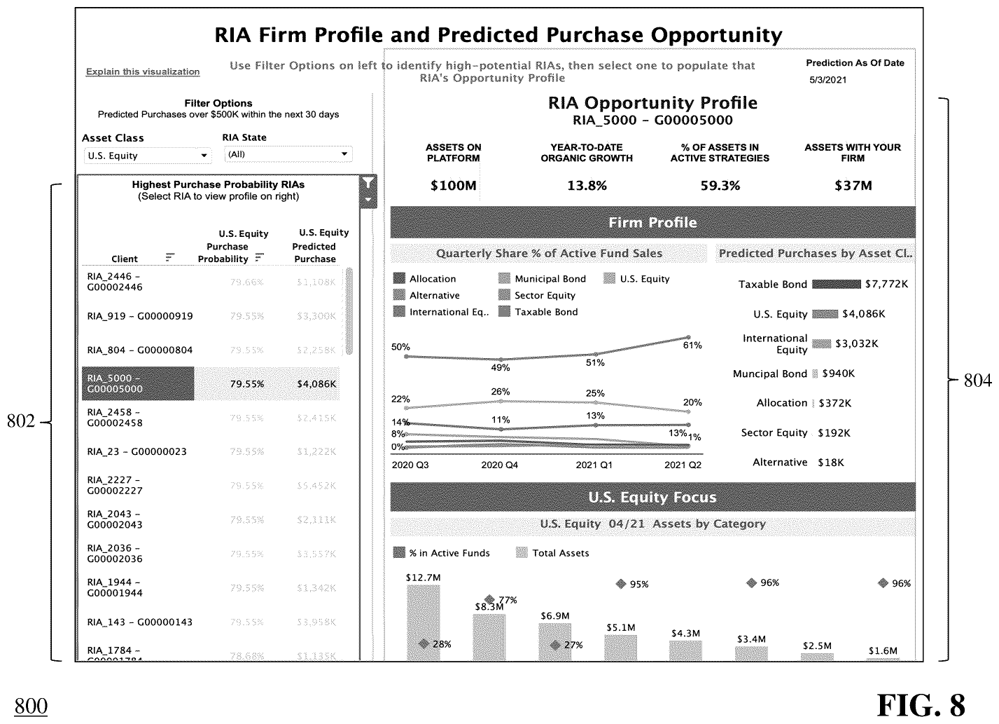

FIG. 8 is an exemplary user interface screen 800 showing an RIA opportunity profile for a selected RIA client. As shown in FIG. 8, the interface screen includes table 802 that lists RIA clients by prediction likelihood value for a given asset class selection and/or state selection. When a user selects one of the RIA clients in table 802, the user interface screen 800 displays an opportunity profile view 804 for the selected RIA client. The opportunity profile 804 includes detailed prediction data for the selected RIA client, along with supporting information about the RIA client (e.g., from databases 102a-102c). In some embodiments, the opportunity profile includes charts, graphs, and other visual representations of the prediction data to provide the user with an interactive and easy-to-understand depiction of the prediction data-which enables the user to quickly leverage the prediction data to develop a course of action.

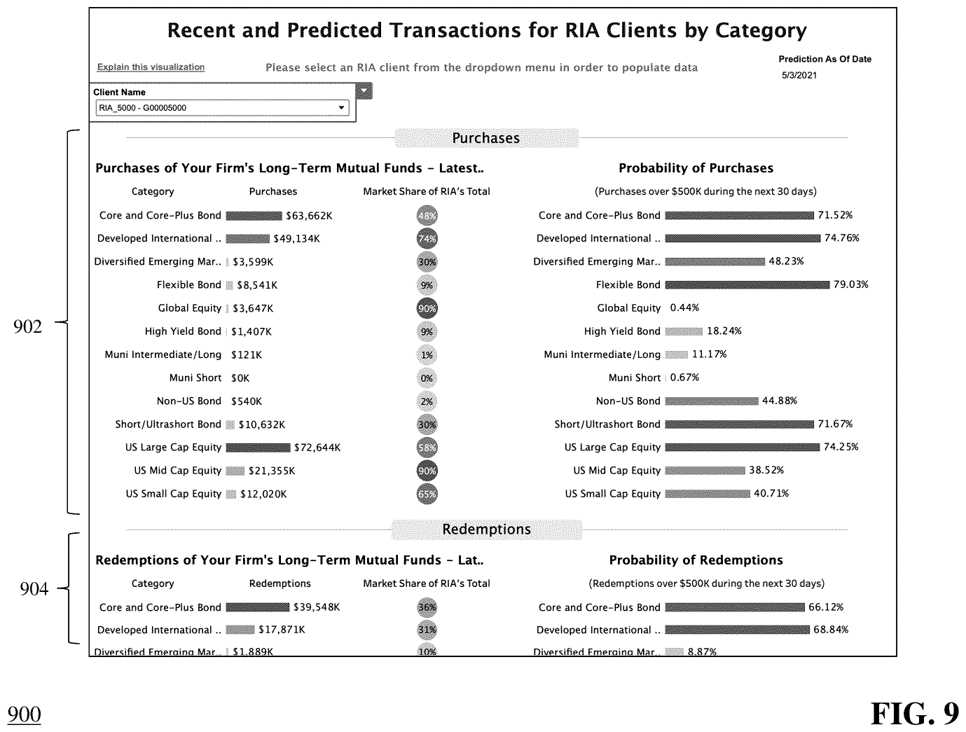

FIG. 9 is an exemplary user interface screen 900 showing a prediction ‘heat map’ for a selected RIA client. As shown in FIG. 9, the user interface screen 900 includes a display area 902 with the predicted likelihood values for purchase transactions associated with each of a plurality of asset types/asset categories for a selected RIA client. The screen also includes a display area 904 with the predicted likelihood values for redemption transactions associated with each of a plurality of asset types/asset categories for the selected RIA client. In some embodiments, the predicted likelihood values in areas 902 and 904 are color-coded according to the prediction values—for example, likelihood values may be colored in a spectrum from green (indicating high likelihood) to yellow (indicating moderate likelihood) to red (indicating low likelihood). Based upon these color values, a user can quickly determine which assets should be emphasized to the RIA client and which might be de-emphasized in an upcoming marketing contact. It should be appreciated that the user interface screens in FIGS. 7 to 9 are merely exemplary, and other types of interfaces or presentations of the prediction data generated by system 100 can be contemplated.

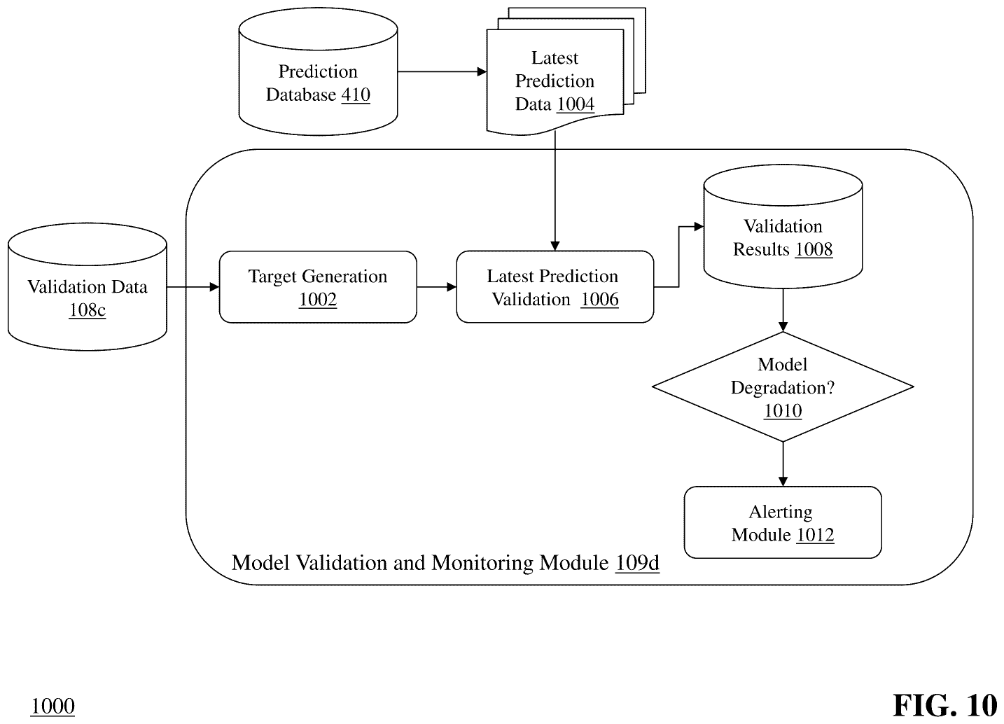

Another important feature of system 100 is the ability to continually monitor and validate the prediction data generated by the trained ML models and to determine when the predictions generated by the trained ML models begin to degrade. FIG. 10 is a flow diagram of an exemplary process 1000 for validating the predictions generated by the trained ML models. Model validation and monitoring module 109d retrieves recent historical transaction data for one or more top-performing RIAs from validation data store 108c and executes a target generation process 1002 which determines whether each of the RIAs is associated with transaction activity for one or more target transaction variables that occurred in a particular historical rolling window. For example, module 109d can determine that a given RIA client executed a purchase transaction 30 days ago for U.S. Mid-Cap Equities that was greater than $500,000. Module 109d can compare the actual historical transaction data against the latest prediction data 1004 retrieved from prediction database 410 using a latest prediction validation process 1006 to identify whether the predicted likelihood value that the RIA would execute such a transaction is reflective of the actual historical transaction data. In some embodiments, the comparison results in a distance metric (e.g., a difference between the predicted likelihood and the actual outcome) that is used to determine the accuracy of the trained ML models. In some embodiments, module 109d stores the comparison data and/or distance metrics in validation results database 1008.

In addition, model validation and monitoring module 109d can utilize the comparison data to determine whether performance and/or accuracy of the plurality of ML models has degraded. For example, as new transaction data is received and processed by system 100, the ML models may become less accurate because they were originally trained on a historical transaction data set that did not contain the more recent transaction data (which could include transaction patterns or trends that were not present in the earlier data). Therefore, when the model accuracy has degraded below a particular threshold (step 1010) based upon the validation results 1008, model training and validation module 109d can trigger alerting module 1012 to issue one or more alerts to remote computing devices (e.g., operated by a data science team) that instruct the recipients to monitor the ML models' performance and/or initiate a re-training process for the ML models using the most recent historical transaction data.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM® Cloud).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The above-described techniques can be implemented using supervised learning and/or machine learning algorithms. Supervised learning is the machine learning task of learning a function that maps an input to an output based on example input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for predictive analysis of transaction data using machine learning, the system comprising a server computing device comprising a memory for storing programmatic instructions and a processor that executes the programmatic instructions to:
train a plurality of machine learning models using historical transaction data for a set of entities as input to predict a likelihood of future transaction activity for each of the entities including:
creating an initial feature set based upon the historical transaction data for one or more rolling time periods,
determining a plurality of target transaction variables based upon the historical transaction data for one or more rolling time periods,
generating a variable-specific feature set for each target transaction variable using a feature selection process on the initial feature set, and
training a plurality of machine learning models using the historical transaction data, each machine learning model trained on a variable-specific feature set for a different target transaction variable;
execute each of the plurality of trained machine learning models to generate, for each entity, a predicted likelihood value for a future transaction associated with the entity and each of the target transaction variables; and
transmit the predicted likelihood values for each entity to a remote computing device for display.

2. The system of claim 1, wherein each machine learning model comprises a tree-based machine learning model.

3. The system of claim 1, wherein each of the plurality of target transaction variables corresponds to a different type of classification.

4. The system of claim 3, wherein the type of classification comprises a category or an asset class.

5. The system of claim 1, wherein the feature selection process comprises a pipeline that performs a separate feature selection for each target transaction variable using the initial feature set to generate the variable-specific feature set for each target transaction variable.

6. The system of claim 5, wherein the pipeline includes a correlative feature selector that is applied to reduce the number of features in the initial feature set before the separate feature selection is performed.

7. The system of claim 1, wherein executing each of the plurality of trained machine learning models comprises:
generating, for each entity and trained machine learning model combination, model feature data by combining entity-specific historical transaction data and a variable-specific feature set for the target transaction variable associated with the trained machine learning model; and
executing the trained machine learning model using the model feature data as input to generate a predicted likelihood value for a future transaction associated with the entity and the target transaction variable.

8. The system of claim 1, wherein transmitting the predicted likelihood values for each entity to a remote computing device for display comprises:
merging screening attributes with the predicted likelihood values for each entity to generate a merged output dataset; and
transmitting the merged output dataset to the remote computing device.

9. The system of claim 8, wherein the remote computing device generates a user interface screen for display of the merged output data.

10. The system of claim 1, wherein the server computing device periodically validates at least one of performance or accuracy of the plurality of trained machine learning models using newly-received historical transaction data.

11. A computerized method of predictive analysis of transaction data using machine learning, the method comprising:
training, by a server computing device, a plurality of machine learning models using historical transaction data for a set of entities as input to predict a likelihood of future transaction activity for each of the entities including:
creating an initial feature set based upon the historical transaction data for one or more rolling time periods,
determining a plurality of target transaction variables based upon the historical transaction data for one or more rolling time periods,
generating a variable-specific feature set for each target transaction variable using a feature selection process on the initial feature set, and
training a plurality of machine learning models using the historical transaction data, each machine learning model trained on a variable-specific feature set for a different target transaction variable;
executing, by the server computing device, each of the plurality of trained machine learning models to generate, for each entity, a predicted likelihood value for a future transaction associated with the entity and each of the target transaction variables; and
transmitting, by the server computing device, the predicted likelihood values for each entity to a remote computing device for display.

12. The method of claim 11, wherein each machine learning model comprises a tree-based machine learning model.

13. The method of claim 11, wherein each of the plurality of target transaction variables corresponds to a different type of classification.

14. The method of claim 13, wherein the type of classification comprises a category or an asset class.

15. The method of claim 11, wherein the feature selection process comprises a pipeline that performs a separate feature selection for each target transaction variable using the initial feature set to generate the variable-specific feature set for each target transaction variable.

16. The method of claim 15, wherein the pipeline includes a correlative feature selector that is applied to reduce the number of features in the initial feature set before the separate feature selection is performed.

17. The method of claim 11, wherein executing each of the plurality of trained machine learning models comprises:
generating, for each entity and trained machine learning model combination, model feature data by combining entity-specific historical transaction data and a variable-specific feature set for the target transaction variable associated with the trained machine learning model; and
executing the trained machine learning model using the model feature data as input to generate a predicted likelihood value for a future transaction associated with the entity and the target transaction variable.

18. The method of claim 11, wherein transmitting the predicted likelihood values for each entity to a remote computing device for display comprises:
merging screening attributes with the predicted likelihood values for each entity to generate a merged output dataset; and
transmitting the merged output dataset to the remote computing device.

19. The method of claim 18, wherein the remote computing device generates a user interface screen for display of the merged output data.

20. The method of claim 11, wherein the server computing device periodically validates at least one of performance or accuracy of the plurality of trained machine learning models using newly-received historical transaction data.
